(19) United States
(12) Patent Application Publication
(10) Pub. No.: US 2009/0168235 A1
(43) Pub. Date: Jul. 2, 2009

(54) ENHANCED CPP READ SENSORS WITH LATERAL SPIN TRANSPORT

(76) Inventors: Kochan Ju, Monte Sereno, CA (US); Ching Hwa Tsang, Sunnyvale, CA (US)

Correspondence Address: DUFT BORNSEN & FISHMAN, LLP, 1526 SPRUCE STREET, SUITE 302, BOULDER, CO, 80302, US

(21) Appl. No.: 11/965,663

(22) Filed: Dec. 27, 2007

(51) Int. Cl. G11B 5/127

(52) U.S. Cl. 360/110

(57) ABSTRACT

CPP read sensors and associated methods of fabrication are described that provide lateral spreading of a sense current along the length of an AFM layer of the read sensor. Winged regions (i.e., extended portions) are added to the layers of a CPP sensor stack to induce lateral spreading of the sense current in the AFM layer. Particularly, the pinned layer and the AFM layer have widths greater than the other layers of the sensor stack. Further, the pinned layer comprises multiple layers of materials, with a first layer of material closer to the AFM layer having a lower conductivity and/or a lower spin dependent scattering asymmetry than the second layer of material.

### BACKGROUND OF THE INVENTION

1. Field of the Invention

The invention is related to the field of magnetic recording disk drive systems and, in particular, to enhanced current perpendicular to plane (CPP) read sensors with lateral spin transport that spread current laterally across both the reference and anti-ferro magnetic (AFM) layer.

2. Statement of the Problem

Magnetic hard disk drive systems typically include a magnetic disk, a recording head having write and read elements, a suspension arm, and an actuator arm. As the magnetic disk is rotated, air adjacent to the disk surface moves with the disk. This allows the recording head (also referred to as a slider) to fly on an extremely thin cushion of air, generally referred to as an air bearing. When the recording head flies on the air bearing, the actuator arm swings the suspension arm to place the recording head over selected circular tracks on the rotating magnetic disk where signal fields are written to and read by the write and read elements, respectively. The write and read elements are connected to processing circuitry that operates according to a computer program to implement write and read functions.

In a disk drive utilizing perpendicular recording, data is recorded on a magnetic recording disk by magnetizing the recording medium in a direction perpendicular to the surface of the disk. CPP sensors typically include a sensor stack comprising an AFM layer, a reference layer, a spacer layer, a free layer, and a cap layer. The sensor stack is electrically coupled between two shield layers. Sense current flows from the upper shield through the sensor stack into the lower shield at a uniform current density. An output voltage of the read sensor represents a bit read by the read sensor.

The voltage generated when a sense current is passed through a read sensor is equal to the sum, over all interfaces and layers, of jₙΔRAₙ, where jₙ is the current density in that layer or interface, and ΔRAₙ is the magnetoresistance-area product of that layer or interface. It is a problem that the ΔRAₙ of present CPP read sensors is inadequate. Particularly, the AFM layer provides a great amount of parasitic resistance, which affects the signal strength (e.g., the voltage) of the read sensor. The parasitic resistance of the AFM layer decreases the voltage of the signal, and converts the signal current into unwanted heat. Thus, improvements in the signal amplitude capability are needed in order to utilize CPP read sensors in high density recording applications.

### SUMMARY OF THE SOLUTION

Embodiments of the invention solve the above and other related problems with CPP read sensors and associated methods of fabrication that are capable of laterally spreading current out along the length of the AFM layer. Winged regions (i.e., extended portions) are added to layers of the CPP sensor stack to induce lateral spreading of the sense current in both the reference and AFM layer. Particularly, the pinned layer and the AFM layer have widths greater than the other layers of the sensor stack. This increases the value of ΔRA for the read sensor and improves the strength of the signal. Because the sense current is diffused across the AFM layer, the result is a reduction of the parasitic resistance and heat generated by the AFM layer. Advantageously, a stronger read signal is generated by the read sensor.

One embodiment of the invention comprises a CPP read sensor including an AFM layer, a pinned layer structure, a spacer layer, and a free layer. The pinned layer structure includes a first pinned layer comprised of a first material and proximate to the AFM layer, and a second pinned layer comprised of a second material. The second material has the properties of a higher conductivity and/or a higher spin dependent scattering asymmetry than the first material. Further, the AFM layer, the first pinned layer, and the second pinned layer have widths greater than the free layer and the spacer layer. As sense current is injected into the CPP read sensor, the described structure provides lateral spreading of the sense current from the pinned layer structure into the AFM layer. Thus, less of the read signal is degraded by the parasitic resistance of the AFM layer.

Another embodiment comprises a method of fabricating a CPP read sensor. The method comprises forming an AFM layer, forming a first pinned layer comprised of a first material, and forming a second pinned layer comprised of a second material. The second material has the properties of a higher conductivity and/or a higher spin dependent scattering asymmetry than the first material. The method further comprises forming a spacer layer having a width less than the AFM layer, the first pinned layer, and the second pinned layer, and also forming a free layer having a width less than the AFM layer, the first pinned layer, and the second pinned layer.

The invention may include other exemplary embodiments described below.

### DESCRIPTION OF THE DRAWINGS

The same reference number represents the same element or same type of element on all drawings.

FIG. 1 illustrates a magnetic disk drive system in an exemplary embodiment of the invention.

FIG. 2 illustrates a recording head in an exemplary embodiment of the invention.

FIG. 3 illustrates an air bearing surface (ABS) view of a read sensor in an exemplary embodiment of the invention.

FIG. 4 illustrates an ABS view of another read sensor in an exemplary embodiment of the invention.

FIG. 5 illustrates a read sensor in another exemplary embodiment of the invention.

FIG. 6 illustrates a method for fabricating a CPP read sensor in an exemplary embodiment of the invention.

FIG. 7 illustrates another method for fabricating a CPP read sensor in an exemplary embodiment of the invention.

FIGS. 8-9 illustrate side views of a read sensor during fabrication according to the method of FIG. 7 in exemplary embodiments of the invention.

### DETAILED DESCRIPTION OF THE INVENTION

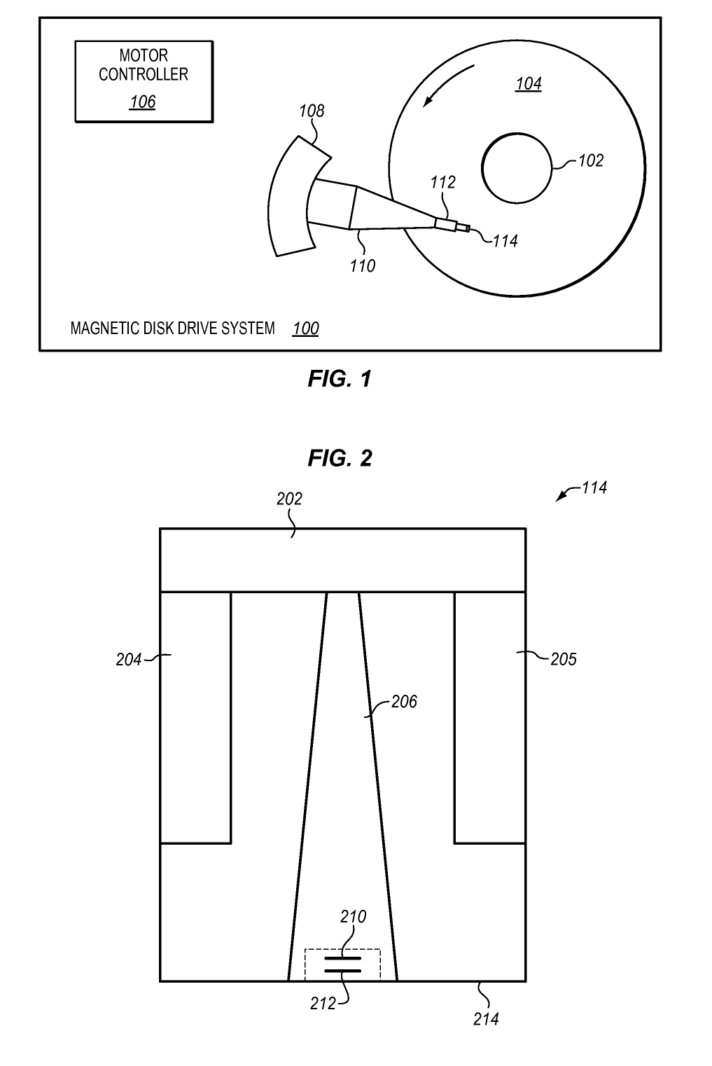

FIGS. 1-9 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a magnetic disk drive system 100 in an exemplary embodiment of the invention. Magnetic disk drive system 100 includes a spindle 102, a magnetic disk 104, a motor controller 106, an actuator 108, an actuator arm 110, a suspension arm 112, and a recording head 114. Spindle 102 supports and rotates a magnetic disk 104 in the direction indicated by the arrow. A spindle motor (not shown) rotates spindle 102 according to control signals from motor controller 106. Recording head 114 is supported by suspension arm 112 and actuator arm 110. Actuator arm 110 is connected to actuator 108 that is configured to rotate in order to position recording head 114 over a desired track of magnetic disk 104. Magnetic disk drive system 100 may include other devices, components, or systems not shown in FIG. 1. For instance, a plurality of magnetic disks, actuators, actuator arms, suspension arms, and recording heads may be used.

When magnetic disk 104 rotates, air generated by the rotation of magnetic disk 104 causes an air bearing surface (ABS) of recording head 114 to ride on a cushion of air a particular height above magnetic disk 104. The height depends on the shape of the ABS. As recording head 114 rides on the cushion of air, actuator 108 moves actuator arm 110 to position a read element (not shown) and a write element (not shown) in recording head 114 over selected tracks of magnetic disk 104.

FIG. 2 illustrates recording head 114 in an exemplary embodiment of the invention. The view of recording head 114 is of the ABS side of recording head 114. Recording head 114 has a cross rail 202, two side rails 204-205, and a center rail 206 on the ABS side. The rails on recording head 114 illustrate just one embodiment, and the configuration of the ABS side of recording head 114 may take on any desired form. Recording head 114 also includes a write element 210 and a read sensor 212 on a trailing edge 214 of recording head 114.

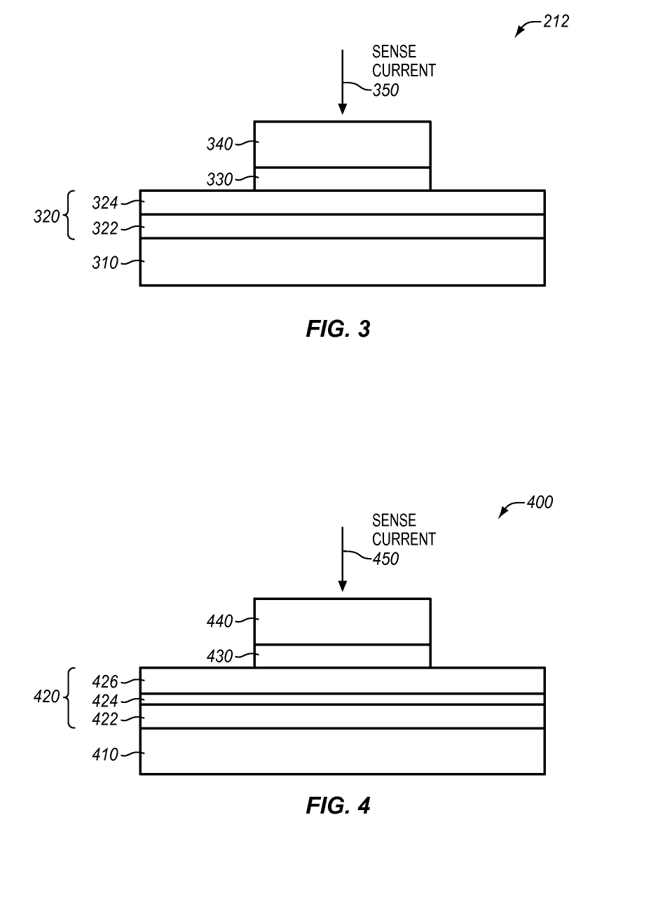

FIG. 3 illustrates an ABS view of read sensor 212 in an exemplary embodiment of the invention. Read sensor 212 includes an AFM layer 310, a pinned layer structure 320, a spacer layer 330, and a free layer 340. AFM layer 310 comprises a high resistivity material, such as CoZrX or another material having a resistivity greater than 100 uΩ/cm. AFM layer 310 and pinned layer structure 320 have widths (i.e., the dimension parallel to the ABS along the major planes of the layers) greater than spacer layer 330 and free layer 340. For example, AFM layer 310 and pinned layer structure 320 may each have a width in the range of 1.6 to 5 times greater than the widths of spacer layer 330 and free layer 340. There may be other layers of read sensor 212 not illustrated for the sake of brevity.

Pinned layer structure 320 includes a first pinned layer 322 comprising a first material, and a second pinned layer 324 comprising a second material. Although the term “layer” is used in singular form, a “layer” may actually be comprised of multiple layers. First pinned layer 322 is proximate to AFM layer 310. Second pinned layer 324 may have a greater thickness than first pinned layer 322. The second material has a higher conductivity and/or a higher spin dependent scattering asymmetry than the first material. The spin dependent transport leads to a spin dependent broadening of the current distribution pattern in AFM layer 310 (i.e., sense current 350 spreads laterally in AFM layer 310). A sense current 350 is injected into read sensor 212 through free layer 340. Thus, because pinned layer structure 320 is wider than free layer 340, the sense current 350 spreads laterally in a spin dependent fashion into a larger area as it flows into AFM layer 310. This results in a net increase in the parallel versus anti-parallel resistance (i.e., an increase in the delta areal resistance ΔRA).

Because sense current 350 spreads laterally across AFM layer 310, the parasitic resistance of AFM layer 310 has less affect on the sense current 350. This means there is less of a voltage drop caused by AFM layer 310, and less heat is dissipated by AFM layer 310 as sense current 350 passes through AFM layer 310. Thus, the effective resistance of read sensor 212 is reduced. An output voltage of sense signal 350 therefore has a higher magnitude than a read sensor that does not provide lateral spreading of the sense current 350 into an AFM layer. This increased signal amplitude capability is beneficial for deployment of CPP sensors in high density recording applications.

The material and physical properties of first pinned layer 322 and second pinned layer 324 may be selected to optimize the current spreading capability of read sensor 212, which increases the signal amplitude capability of read sensor 212. For example, second pinned layer 324 may comprise a material having a high-spin scattering asymmetry, β, in which β of the material is greater than or equal to 0.5. Exemplary materials having a high-spin scattering asymmetry, β, include CoFe and a Permalloy with a long spin diffusion length. The long spin diffusion length may be greater than or equal to 10 nanometers. First pinned layer 322 may comprise a high resistivity ferro-magnet having a low spin-scattering asymmetry, β. The value of β for a material having a low spin-scattering asymmetry may be less than or equal to 0.2. The width of AFM layer 310, first pinned layer 322, and second pinned layer 324 may be at least 5 times the width of spacer layer 330 and free layer 340. Thus, first pinned layer 322 and second pinned layer 324 increase the ΔRA of read sensor 212, and decrease the overall resistance of read sensor 212.

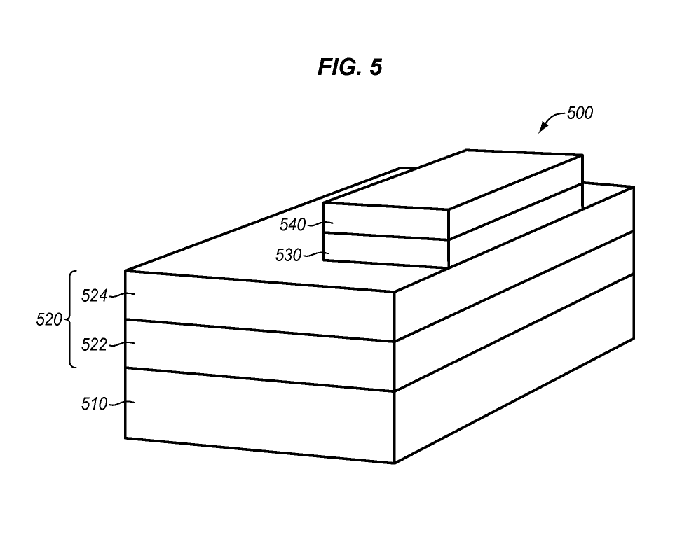

Read sensor 212 may be implemented in synthetic pin configurations (i.e., an anti-parallel (AP) pinned layer structure). FIG. 4 illustrates an ABS view of another read sensor 400 in an exemplary embodiment of the invention. Read sensor 400 includes an AFM layer 410, a pinned layer structure 420, a spacer layer 430, and a free layer 440. AFM layer 410, spacer layer 430, and free layer 440 are similar to AFM layer 310, spacer layer 330, and free layer 340 of FIG. 3. AFM layer 410 and pinned layer structure 420 have widths greater than spacer layer 430 and free layer 440.

Pinned layer structure 420 comprises an anti-parallel pinned layer structure. Pinned layer structure 420 includes a first pinned layer 422 and a second pinned layer 426 separated by an AP spacer layer 424. First pinned layer 422 and second pinned layer 426 may be similar to first pinned layer 322 and second pinned layer 324 of FIG. 3, respectively. Thus, first pinned layer 422 comprises a first anti-parallel pinned layer, and second pinned layer 426 comprises a second anti-parallel pinned layer. AP spacer layer 424 may be Ru or a material having equivalent properties. The spin-scattering asymmetry, β, of first pinned layer 422 may be less than 0.2, and may have a mild negative value.

Read sensor 212 of FIG. 3 and read sensor 400 of FIG. 4 illustrate layers of the sensor stacks extended in a single dimension. However, the winged regions may be extended in two dimensions, such that the winged regions are extended along both the width and the depth of the layers. FIG. 5 illustrates a read sensor 500 in another exemplary embodiment of the invention. Read sensor 500 comprises an AFM layer 510, a pinned layer structure 520 including first pinned layer 522 and second pinned layer 524, a spacer layer 530, and a free layer 540. Each of the layers of read sensor 500 are similar to the layers of read sensor 212 of FIG. 3. However, in addition to having greater widths than spacer layer 530 and free layer 540, the AFM layer 510, first pinned layer 522, and second pinned layer 524 also have depths (i.e., the dimension perpendicular to the ABS along the major planes of the layers) greater than spacer layer 530 and free layer 540. Thus, AFM layer 510, first pinned layer 522, and second pinned layer 524 are extended in multiple directions from the other layers of read sensor 500 as illustrated in FIG. 5. This further reduces the stack resistance and increases the ΔRA of read sensor 500.

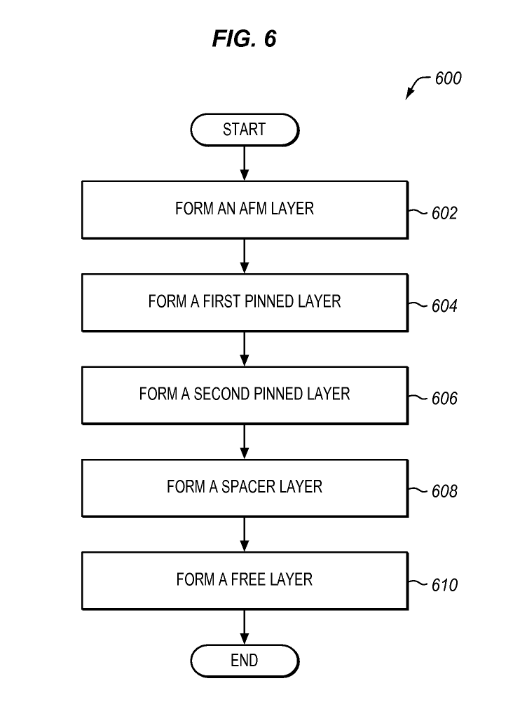

FIG. 6 illustrates a method 600 for fabricating a CPP read sensor in an exemplary embodiment of the invention. The steps of method 600 will be discussed in regard to read sensor 212 of FIG. 3. The steps of method 600 are not all inclusive, and may include other steps not shown for the sake of brevity.

Step 602 comprises forming an AFM layer 310. Step 604 comprises forming a first pinned layer 322 comprised of a first material. Step 606 comprises forming a second pinned layer 324 comprised of a second material. The second material has a higher conductivity and/or a higher spin dependent scattering asymmetry than the first material. Step 608 comprises forming a spacer layer 330 having a width less than the widths of AFM layer 310, first pinned layer 322, and second pinned layer 324. Step 610 comprises forming a free layer 340 having a width less than the widths of AFM layer 310, first pinned layer 322, and the second pinned layer 324. The formation steps 602-610 may comprise standard wafer level fabrication and removal processes that define a sensor stack of read sensor 212.

The extended regions of AFM layer 310, first pinned layer 322, and second pinned layer 324 may be formed utilizing several different types of processes. In one process, the layers of the sensor stack are constructed of substantially uniform width (and/or length), and then partial milling is utilized to reduce the width of spacer layer 330 and free layer 340. Thus, AFM layer 310, first pinned layer 322, and second pinned layer 324 have extended widths in relation to spacer layer 330 and free layer 340. In another exemplary process, a sensor stack may be constructed of substantially uniform width (and/or length), and then extended portions of AFM layer 310, first pinned layer 322, and second pinned layer 324 may be stitched to the sensor stack to increase the widths of these layers.

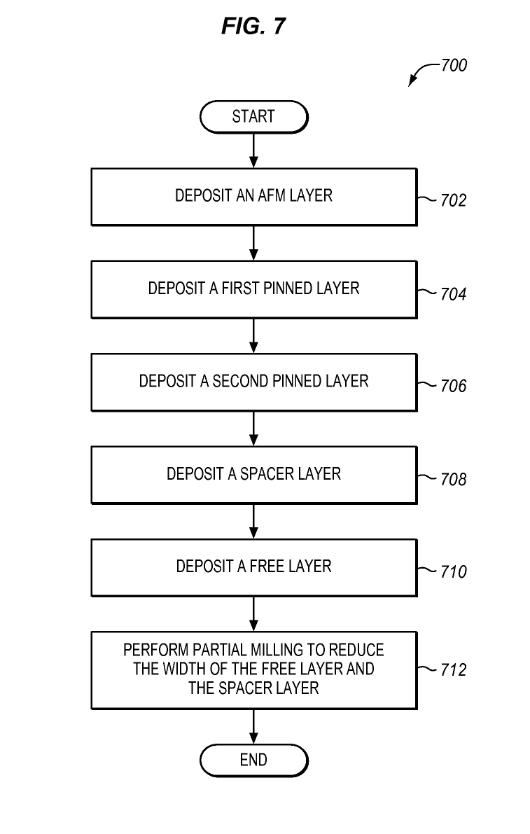

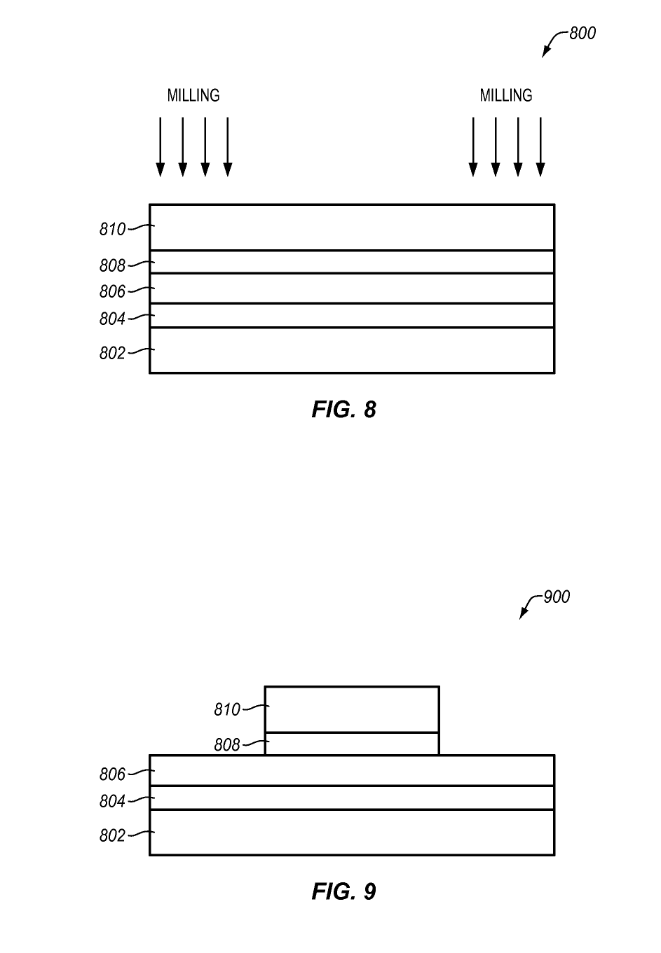

FIG. 7 illustrates another method 700 for fabricating a CPP read sensor in an exemplary embodiment of the invention. Particularly, method 700 illustrates a process in which partial milling is performed to reduce the width (and/or lengths) of some of the layers of a read sensor, thus, giving an extended effect for lower layers of the sensor stack. FIGS. 8-9 illustrate side views of a read sensor 800 during fabrication according to the method of FIG. 7, and the steps of method 700 will be discussed in regard to read sensor 800 of FIGS. 8-9. The steps of method 700 are not all inclusive, and may include other steps not shown for the sake of brevity.

The method comprises depositing an AFM layer 802 (see FIG. 8) (step 702), depositing a first pinned layer 804 (step 704), depositing a second pinned layer 806 (step 706), depositing a spacer layer 808 (step 708), and depositing a free layer 810 (step 710). FIG. 8 illustrates read sensor 800 after completion of step 710.

Step 712 comprises performing partial milling of spacer layer 808 and free layer 810 to reduce the width (and/or a length) of spacer layer 808 and free layer 810. FIG. 9 illustrates read sensor 800 after completion of step 712. As a result of the partial milling, AFM layer 802, first pinned layer 804, and second pinned layer 806 have extended widths (and/or lengths) in relation to spacer layer 808 and free layer 810. Thus, read sensor 800 exhibits lateral spreading of current into AFM layer 802 and enhanced performance as described above.

Although specific embodiments were described herein, the scope of the invention is not limited to those specific embodiments. The scope of the invention is defined by the following claims and any equivalents thereof.

We claim:

1. A current perpendicular to plane (CPP) read sensor comprising:
an anti-ferromagnetic (AFM) layer;
a pinned layer structure including:
a first pinned layer comprised of a first material and proximate to the AFM layer; and
a second pinned layer comprised of a second material;
a spacer layer; and
a free layer;
the AFM layer, the first pinned layer, and the second pinned layer each having a width greater than a width of the free layer and a width of the spacer layer;
the second material having at least one of a higher conductivity and a higher spin dependent scattering asymmetry than the first material.

2. The CPP read sensor of claim 1 wherein the width of each of the AFM layer, the first pinned layer, and the second pinned layer is at least 1.3 times the width of the free layer and the width of the spacer layer.

3. The CPP read sensor of claim 1 wherein the second material has a spin dependent scattering asymmetry greater than or equal to 0.4.

4. The CPP read sensor of claim 1 wherein the first material comprises a high resistivity ferro-magnet having a spin dependent scattering asymmetry less than or equal to 0.1.

5. The CPP read sensor of claim 1 wherein the second material comprises CoFe.

6. The CPP read sensor of claim 1 wherein the pinned layer structure comprises an anti-parallel (AP) pinned layer structure, and the first pinned layer and the second pinned layer are coupled through a spacer layer.

7. The CPP read sensor of claim 6 wherein the spin dependent scattering asymmetry of the first material is less than 0.1.

8. The CPP read sensor of claim 1 wherein a depth of the AFM layer, the first pinned layer, and the second pinned layer is greater than a depth of the free layer and a depth of the spacer layer.

9. A magnetic disk drive system, comprising:
a magnetic disk; and
a recording head that includes a read sensor for reading data from the magnetic disk, the read sensor comprising:
an anti-ferromagnetic (AFM) layer;
a pinned layer structure including:
a first pinned layer comprised of a first material and proximate to the AFM layer; and
a second pinned layer comprised of a second material;
a spacer layer; and
a free layer;
the AFM layer, the first pinned layer, and the second pinned layer each having a width greater than a width of the free layer and a width of the spacer layer;
the second material having at least one of a higher conductivity and a higher spin dependent scattering asymmetry than the first material.

10. The magnetic disk drive system of claim 9 wherein the width of each of the AFM layer, the first pinned layer, and the second pinned layer is at least 1.3 times the width of the free layer and the width of the spacer layer.

11. The magnetic disk drive system of claim 9 wherein the second material has a high spin dependent scattering asymmetry greater than or equal to 0.4.

12. The magnetic disk drive system of claim 9 wherein the first material comprises a high resistivity ferro-magnet having a spin dependent scattering asymmetry less than equal to 0.1.

13. The magnetic disk drive system of claim 9 wherein the pinned layer structure comprises an anti-parallel (AP) pinned layer structure, and the first pinned layer and the second pinned layer are coupled through a spacer layer.

14. The magnetic disk drive system of claim 13 wherein the spin dependent scattering asymmetry of the first material is less than 0.1.

15. The magnetic disk drive system of claim 9 wherein a depth of each of the AFM layer, the first pinned layer, and the second pinned layer is greater than a depth of the free layer and a depth of the spacer layer.

16. A method of fabricating a current perpendicular to plane (CPP) read sensor, the method comprising:
forming an anti-ferromagnetic (AFM) layer;
forming a first pinned layer comprised of a first material;
forming a second pinned layer comprised of a second material, the second material having at least one of a higher conductivity and a higher spin dependent scattering asymmetry than the first material;
forming a spacer layer having a width less than a width of each of the AFM layer, the first pinned layer, and the second pinned layer; and
forming a free layer having a width less than the width of each of the AFM layer, the first pinned layer, and the second pinned layer.

17. The method of claim 16 wherein the width of each of the AFM layer, the first pinned layer, and the second pinned layer is at least 1.3 times the width of the free layer and the width of the spacer layer.

18. The method of claim 16 wherein the second material has a spin dependent scattering asymmetry greater than or equal to 0.4.

19. The method of claim 16 wherein the first material comprises a high resistivity felto-magnet having a spin dependent scattering asymmetry less than or equal to 0.1.
